(19) United States
(12) Patent Application Publication
(10) Pub. No.: US 2010/0179889 A1
(43) Pub. Date: Jul. 15, 2010

(54) METHODS, SYSTEMS, AND COMPUTER PROGRAMS FOR PROVIDING SHOPPING ASSISTANCE TO CONSUMERS

(75) Inventors: Colin Ward Johnsmeyer, Olathe, KS (US); Patrick Anthony Liekhus, Overland Park, KS (US); Thomas Gregory Brantman, Westwood, KS (US); Stephanie Nicole Brantman, Westwood, KS (US)

Correspondence Address: HOVEY WILLIAMS LLP, 10801 Mastin Blvd., Suite 1000, Overland Park, KS, 66210, US

(73) Assignee: AISLE EXPRESS, LLC, Olathe, KS (US)

(21) Appl. No.: 12/351,575

(22) Filed: Jan. 9, 2009

(51) Int. Cl. G06Q 10/00; G06Q 50/00; G01C 21/00; G06Q 30/00

(52) U.S. Cl. 705/28; 701/300

(57) ABSTRACT

A method, system, and computer program that assist consumers in quickly locating items in a store without requiring dedicated electronics equipment and without requiring the store to map the precise location of every item in the store. One exemplary method includes receiving at a host computer location information representative of locations of a plurality of items in a store; providing at least some of the location information to a mobile communications device operated by a consumer to enable the consumer to locate at least some of the items in the store; receiving from the mobile communications device corrected location information for at least one item in the store; and updating the location information in the host computer to account for the corrected location information.

### BACKGROUND

The present invention relates to methods, systems, and computer programs for providing shopping assistance to consumers.

Consumers often spend a great deal of time attempting to locate desired items in stores. For example, grocery store shoppers often create lengthy shopping lists and then walk up and down a store's aisles until they locate everything on their lists. Because many stores stock a huge variety of products and because different stores stock different combinations of products in each of their aisles, consumers often cannot find everything in their lists on the first pass and must backtrack to certain aisles.

Various methods and systems have been developed to provide shopping assistance to consumers, but these prior art systems require complicated and dedicated electronics equipment such as computerized shopping carts and/or detailed product mapping by the stores.

### SUMMARY

The present invention provides a distinct advance in the art of shopping assistance methods and systems. More particularly, embodiments of the present invention provide a method, system, and computer program that assist consumers in quickly locating items in a store without requiring dedicated electronics equipment and without requiring the store to map the precise location of every item in the store.

One embodiment of the invention is computer-implemented method of providing shopping assistance to consumers comprising the steps: receiving at a host computer location information representative of locations of a plurality of items in a store; providing at least some of the location information to a mobile communications device operated by a consumer to enable the consumer to locate at least some of the items in the store; receiving from the mobile communications device corrected location information for at least one item in the store; and updating the location information in the host computer to account for the corrected location information.

Another embodiment of the invention is a computer-implemented method of mapping locations of items in a store comprising the steps: (a) receiving location information for at least one item in the store from a mobile communication device operated by a consumer; (b) repeating step (a) for a plurality of consumers each operating a mobile communication device; and (c) storing the location information received from at least some of the consumers in memory associated with a host computer, the host computer being accessible by the mobile communication devices.

Yet another embodiment of the invention is a computer-implemented method of mapping locations of items in a store comprising the steps: receiving from a first source data representative of categories of items in the store and data representative of locations within the store for each of the categories; receiving from a second source data representative of items found in many stores; and mapping the data representative of the items found in many stores to the locations in the store based on the categories of items.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer and communications equipment that may be used to implement certain aspects of the present invention;

FIG. 2 is an exemplary screen display that may be displayed by the equipment of FIG. 1 when implementing certain aspects of the invention;

FIG. 3 is another exemplary screen display that may be displayed by the equipment of FIG. 1;

FIG. 4 is another exemplary screen display that may be displayed by the equipment of FIG. 1;

FIG. 5 is another exemplary screen display that may be displayed by the equipment of FIG. 1;

FIG. 6 is another exemplary screen display that may be displayed by the equipment of FIG. 1;

FIG. 7 is another exemplary screen display that may be displayed by the equipment of FIG. 1;

FIG. 8 is another exemplary screen display that may be displayed by the equipment of FIG. 1;

FIG. 9 is another exemplary screen display that may be displayed by the equipment of FIG. 1;

FIG. 10 is another exemplary screen display that may be displayed by the equipment of FIG. 1;

FIG. 11 is another exemplary screen display that may be displayed by the equipment of FIG. 1;

FIG. 12 is another exemplary screen display that may be displayed by the equipment of FIG. 1;

FIG. 13 is another exemplary screen display that may be displayed by the equipment of FIG. 1;

FIG. 14 is another exemplary screen display that may be displayed by the equipment of FIG. 1;

FIG. 15 is another exemplary screen display that may be displayed by the equipment of FIG. 1;

FIG. 16 is another exemplary screen display that may be displayed by the equipment of FIG. 1;

FIG. 17 is another exemplary screen display that may be displayed by the equipment of FIG. 1;

FIG. 18 is another exemplary screen display that may be displayed by the equipment of FIG. 1;

FIG. 19 is another exemplary screen display that may be displayed by the equipment of FIG. 1;

FIG. 20 is another exemplary screen display that may be displayed by the equipment of FIG. 1;

FIG. 21 is another exemplary screen display that may be displayed by the equipment of FIG. 1;

FIG. 22 is another exemplary screen display that may be displayed by the equipment of FIG. 1;

FIG. 23 is another exemplary screen display that may be displayed by the equipment of FIG. 1;

FIG. 24 is another exemplary screen display that may be displayed by the equipment of FIG. 1;

FIG. 25 is another exemplary screen display that may be displayed by the equipment of FIG. 1;

FIG. 26 is another exemplary screen display that may be displayed by the equipment of FIG. 1;

FIG. 27 is another exemplary screen display that may be displayed by the equipment of FIG. 1;

FIG. 28 is another exemplary screen display that may be displayed by the equipment of FIG. 1;

FIG. 29 is another exemplary screen display that may be displayed by the equipment of FIG. 1;

FIG. 30 is another exemplary screen display that may be displayed by the equipment of FIG. 1;

FIG. 31 is another exemplary screen display that may be displayed by the equipment of FIG. 1;

FIG. 32 is another exemplary screen display that may be displayed by the equipment of FIG. 1;

FIG. 33 is another exemplary screen display that may be displayed by the equipment of FIG. 1;

FIG. 34 is another exemplary screen display that may be displayed by the equipment of FIG. 1;

FIG. 35 is another exemplary screen display that may be displayed by the equipment of FIG. 1;

FIG. 36 is another exemplary screen display that may be displayed by the equipment of FIG. 1;

FIG. 37 is another exemplary screen display that may be displayed by the equipment of FIG. 1;

FIG. 38 is another exemplary screen display that may be displayed by the equipment of FIG. 1;

FIG. 39 is another exemplary screen display that may be displayed by the equipment of FIG. 1;

FIG. 40 is another exemplary screen display that may be displayed by the equipment of FIG. 1;

FIG. 41 is another exemplary screen display that may be displayed by the equipment of FIG. 1;

FIG. 42 is another exemplary screen display that may be displayed by the equipment of FIG. 1;

FIG. 43 is another exemplary screen display that may be displayed by the equipment of FIG. 1;

FIG. 44 is another exemplary screen display that may be displayed by the equipment of FIG. 1;

FIG. 45 is another exemplary screen display that may be displayed by the equipment of FIG. 1;

FIG. 46 is another exemplary screen display that may be displayed by the equipment of FIG. 1;

FIG. 47 is another exemplary screen display that may be displayed by the equipment of FIG. 1;

FIG. 48 is another exemplary screen display that may be displayed by the equipment of FIG. 1; and

FIG. 49 is another exemplary screen display that may be displayed by the equipment of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

Embodiments of the present invention provide a method, system, and computer program that assist consumers in quickly locating items in a store without requiring dedicated electronics equipment and without requiring the store to map the precise location of every item in the store, although such store mapping can be done in some embodiments. The invention may be used with any store or other establishment that stocks and sells a plurality of items including a grocery store, clothing store, hardware store, toy store, electronics store, warehouse store, discount store, wholesale store, or retail store

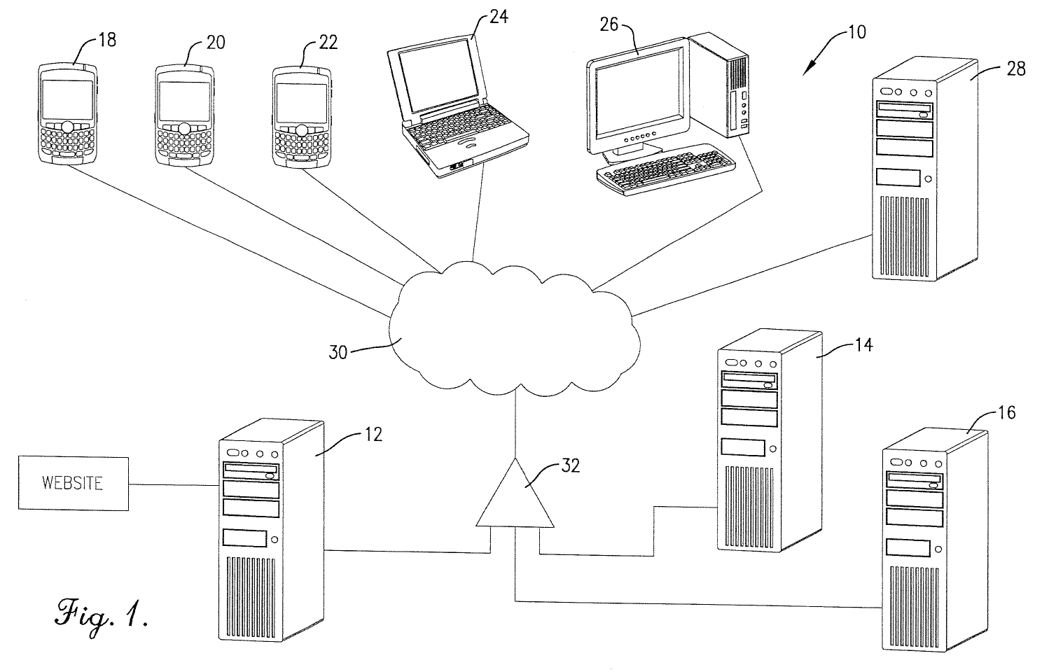

The present invention can be implemented in hardware, software, firmware, or a combination thereof. In one exemplary embodiment, the invention is implemented with a computer program or programs that operate computer and communications equipment broadly referred to by the numeral 10 in FIG. 1. The exemplary computer and communications equipment 10 may include one or more host computers 12, 14, 16 and a plurality of electronic devices 18, 20, 22, 24, 26, 28 that may access the host computers via a communications network 30. The computer programs and equipment illustrated and described herein are merely examples of programs and equipment that may be used to implement embodiments of the invention and may be replaced with other programs and computer equipment without departing from the scope of the invention.

The host computers 12, 14, 16 may serve as repositories for data and programs used to implement certain aspects of the present invention as described in more detail below. The host computers 12, 14, 16 may be any computing devices such as network or server computers and may be connected to a firewall to prevent tampering with information stored on or accessible by the computers. The functionality of the host computers may also be distributed amongst many different computers in a cloud computing environment.

One of the host computers, such as host computer 12, may be a device that operates or hosts a website accessible by at least some of the devices 18-28. The host computer 12 includes conventional web hosting operating software, an Internet connection such as a cable connection, satellite connection, DSL converter, or ISDN converter, and is assigned a URL and corresponding domain name such as “www.aisleexpress.com” and/or “www.aisleexpress.mobi” so that the website hosted thereon can be accessed via the Internet in a conventional manner.

The host computers 14, 16 may host and support software and services of proprietary mobile application providers such as Google, Apple, and Blackberry. For example, the host computer 14 may support Google Android mobile applications and the host computer 16 may support Apple iPhone mobile applications.

Although three host computers 12, 14, 16 are described and illustrated herein, embodiments of the invention may use any combination of host computers and/or other computers or equipment. For example, the features and services described herein may be divided between the host computers 12, 14, 16 or may all be implemented with only one of the host computers.

The computer and communications equipment 10 may also include or use a data interchange format device 32 for distinguishing the types of devices (e.g. mobile phone, desktop computer) that attempt to access the host computers 12, 14, 16 and for routing communications and requests to the host computers accordingly.

The electronic devices 18-28 may be used by shoppers, store owners, store employees, and/or others wishing to view, receive, and/or provide information described herein. The electronic devices 18-28 may be any types of devices that can access to the host computers 12, 14, 16 via the communications network 30. Each electronic device 18-28 preferably includes or can access a web browser and a conventional Internet connection such as a wireless broadband connection, a modem, DSL converter, or ISDN converter that permits it to access the Internet.

The electronic devices 18-28 may include, for example, one or more mobile communications devices 18, 20, 22 such as wireless phones, phone-enabled personal digital assistants (PDAs) manufactured by or for Apple or Blackberry, MP3 devices, handheld game players, or any other wireless communication device. Such mobile communication devices may be operated by shoppers or consumers as discussed in more detail below.

The electronic devices 18-28 may also include one or more laptop, personal, or network computers 24, 26, 28 operated by one or more stores as discussed in more detail below. Although FIG. 1 depicts a particular number of electronic devices 18-28, any number of devices may access the host computers 12, 14, 16.

The communications network 30 is preferably the Internet but may be any other communications network such as a local area network, a wide area network, a wireless network, or an intranet. The communications network may also be a combination of several networks. For example, the electronic devices 18-28 may wirelessly communicate with a computer or hub in a store via a WiFi network, which in turn is in communication with one or more of the host computers 12, 14, 16 via the Internet or other communication network.

The computer programs of the present invention are stored in or on computer-readable medium residing on or accessible by the computer and communications equipment 10. The computer programs preferably comprise ordered listings of executable instructions for implementing logical functions in the host computers 12, 14, 16 and/or devices 18-28. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

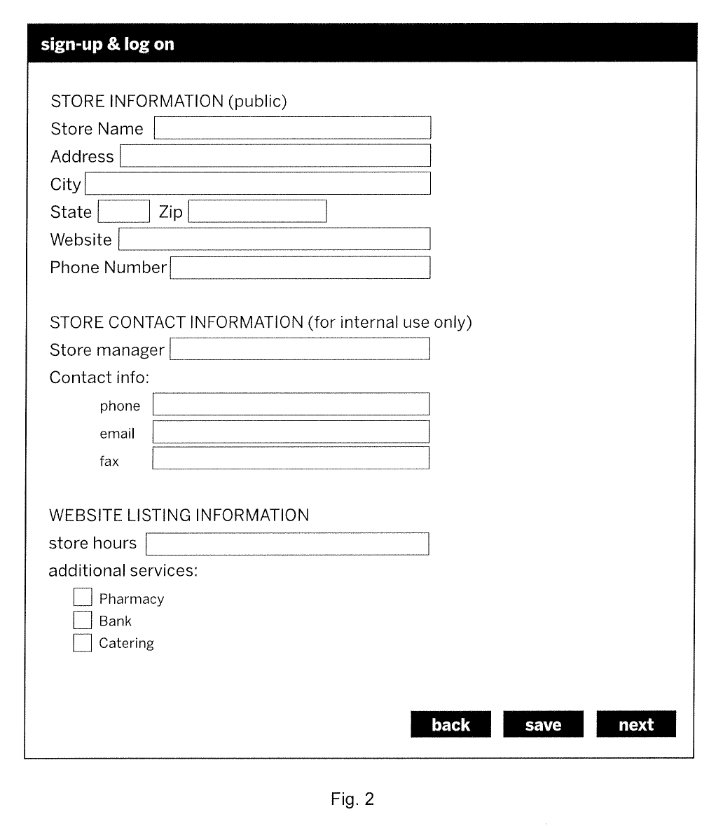

The above-described computer and communications equipment 10 may be used to map the locations of items in a store, update or correct the locations of items already mapped to a store, search for and locate items on a shopping list, find a store that has a desired item, and perform other features described herein. The following paragraphs describe selected features and functions of the invention with reference to the exemplary screen displays of FIGS. 2-49.

### Mapping a Store

To assist shoppers in locating items in a store, the locations of the items must first be mapped to particular aisles, departments, or other discernable areas in the store. Importantly, embodiments of the invention do not require exact mapping of every item in a store to a precise location, but rather only require mapping of broad categories of items to general areas within a store. For example, and as described in more detail below, a store can be partially mapped with the present invention by identifying the aisles or other areas within the store and then identifying which areas contain the categories Carbonated Beverages, Water, Salty Snacks, Juice, and Fresh Fruit (these are examples only). Then, specific items such as Coke®, Aquafina® water, Lays® potato chips, orange juice and apples, respectively, can be mapped to the above-identified aisles or other areas based on the assigned categories.

A store can be mapped (also referred to herein as “set up”) in a number of ways, including but not limited to, by an employee or other representative of the store, by a consumer or other patron of the store, by a number of consumers over time, and/or by a combination of any of these methods. Importantly, many aspects of the present invention can be used before a store is fully mapped or even mapped at all. Moreover, as consumers or store representatives use the invention, a store can be gradually mapped over time as described below.

Mapping by a store employee or other representative is described first in connection with FIGS. 2-9. To map a store, a store representative may use the laptop computer 24, the computer 26, or any other device to access one of the host computers 12, 14, 16. The first time a store representative accesses the host computers, he or she may be asked to create an account.

FIG. 2 shows a sample screen display where a store representative can create an account and enter certain information in a sign-up and log-on screen. After an account has been set up for a store, the user may begin mapping the store.

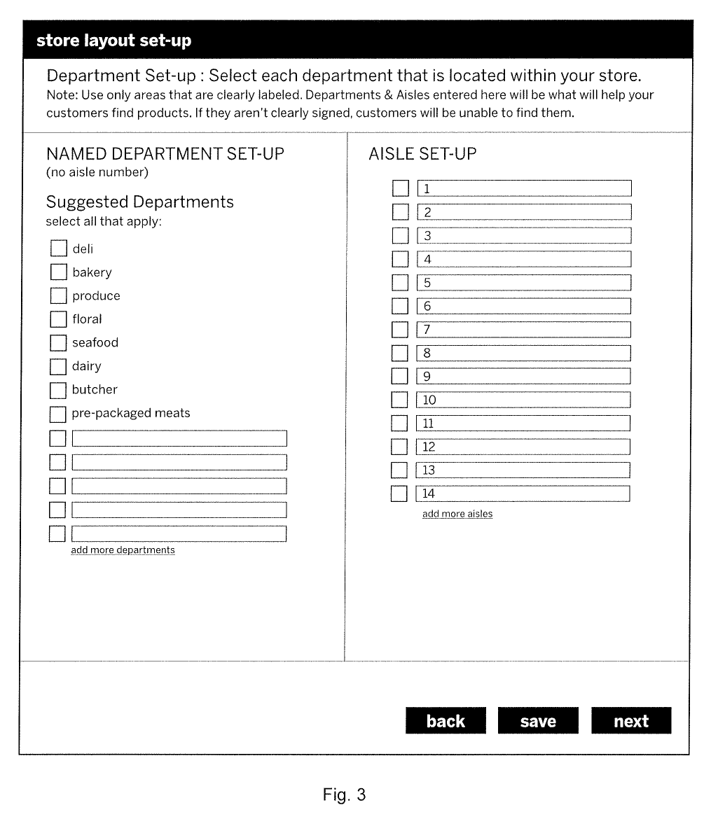

The first step in mapping a store is to identify all the aisles and/or other areas where products are located. FIG. 3 shows a sample screen display where the user may identify all such areas. On the left of the screen is an area where the user can check off areas common to most stores. The user can also add areas that are not on the list by filling in the blanks provided. On the right side of the screen is an area where the user can enter aisle numbers that are specific to the user's store (numbers and/or letters).

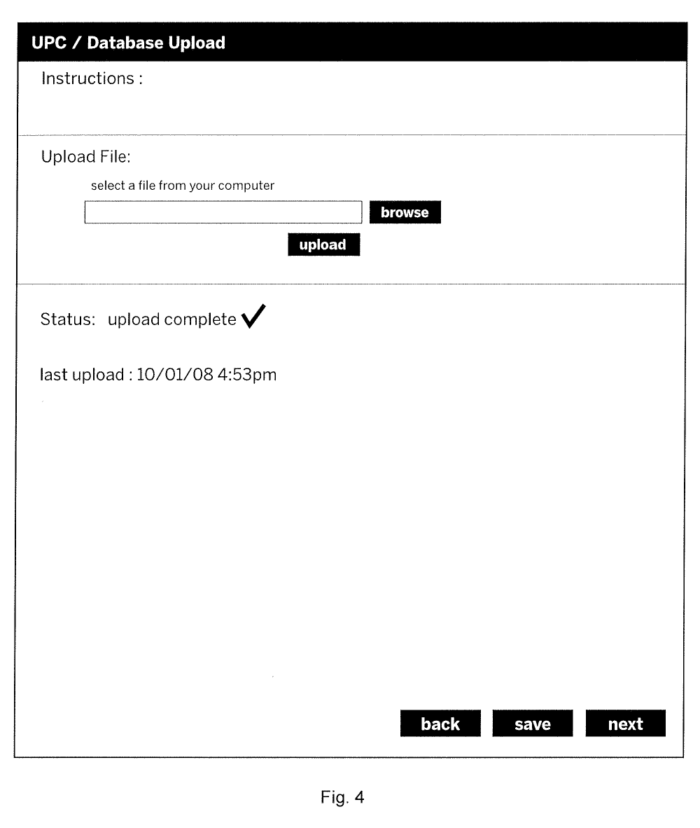

After a store's aisles and other areas are identified, the user may upload their store's product database to one of the host computers 12, 14, 16. The product database may include detailed information for every product or item in the store, including the products' UPC codes, SKUs, and/or descriptions. FIG. 4 shows a sample screen display for this purpose. Stores without a perpetual inventory system can upload files that were exported from their database, and once uploaded, the host computers will show the uploaded time and date so the users can keep track of how current the data is. For stores with perpetual inventory systems, the screen of FIG. 4 will allow the store to locate their database to create a constant link between their database and the host computers. Periodic updates can also be scheduled to occur automatically.

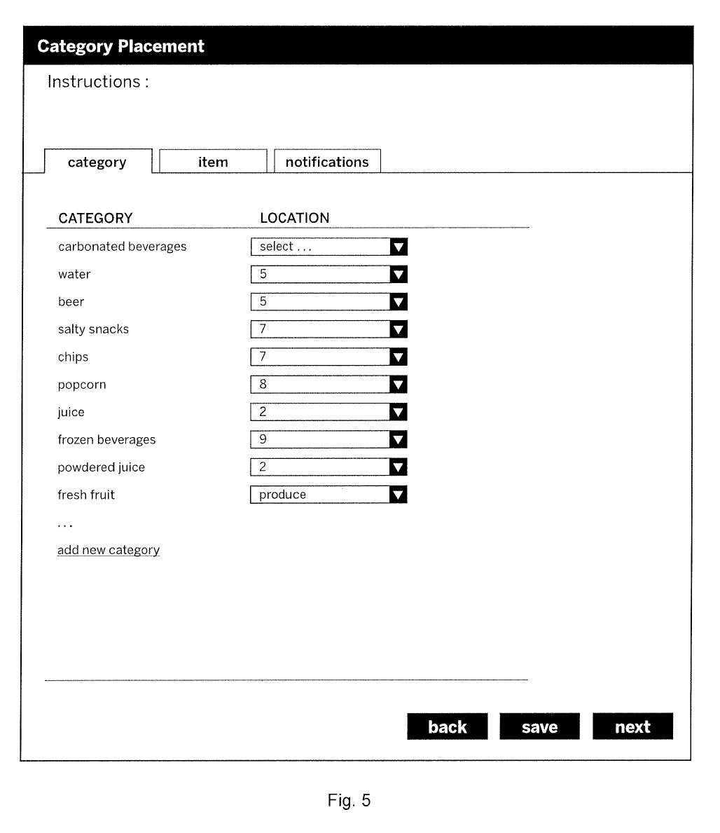

Once a store's aisles and other areas are identified and the store's inventory data is uploaded to or linked to the host computers as described above, the next step in mapping the store is to link or otherwise associate the store's products to the identified areas. FIG. 5 shows a sample Category Placement screen for this purpose. The exemplary Category Placement screen may include tabs for “category,” “item,” and “notifications.” The category tab is shown selected in FIG. 5. To categorize a store's products, the host computers access a store's UPCs and match them to a central database that has a categorized list of all known UPCs. Based on what UPCs the store inputs, the host computers will show all of the categories that are available to that store. This way, the UPCs will be automatically categorized and the store will only have to locate categories, not each product. This is particularly useful for small or specialty stores, as the host computers will only provide categories that actually exist within the stores, as entered by the store in the screen display of FIG. 3.

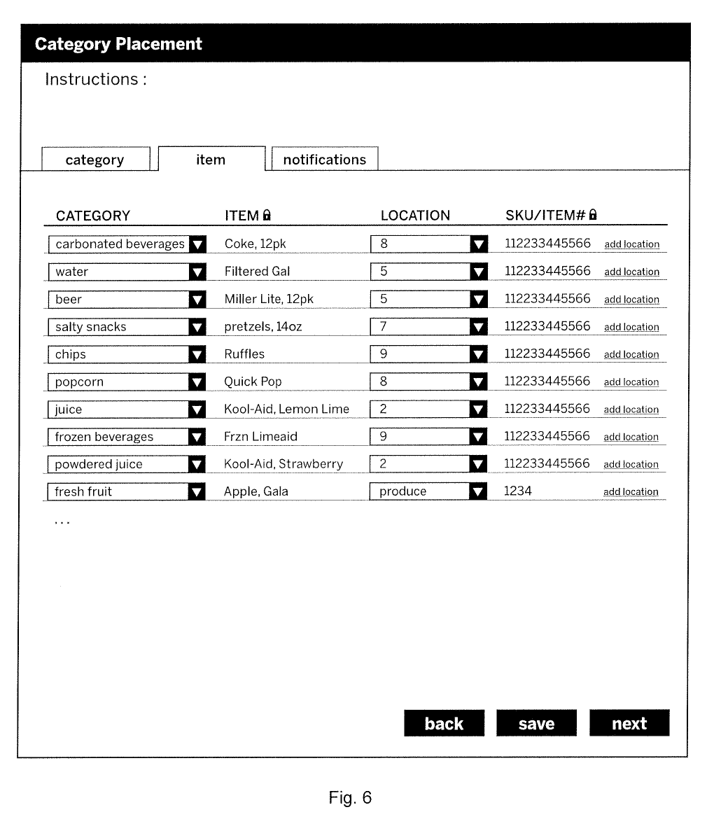

FIG. 6 shows a sample screen display for the item tab where a store can look at a detailed list of actual products or items. This permits a store to move individual items to a different category if the store is organized differently. As mentioned above, categories are tied to location. If a store changes a location, it will clear that item's association to the category. That way, if the category moves, that item will not be moved with it. The category will simply be blank until the store places it back into a category. If the user would like to select a new category, they may from a drop-down list. The only categories available will be those already tied to the location selected.

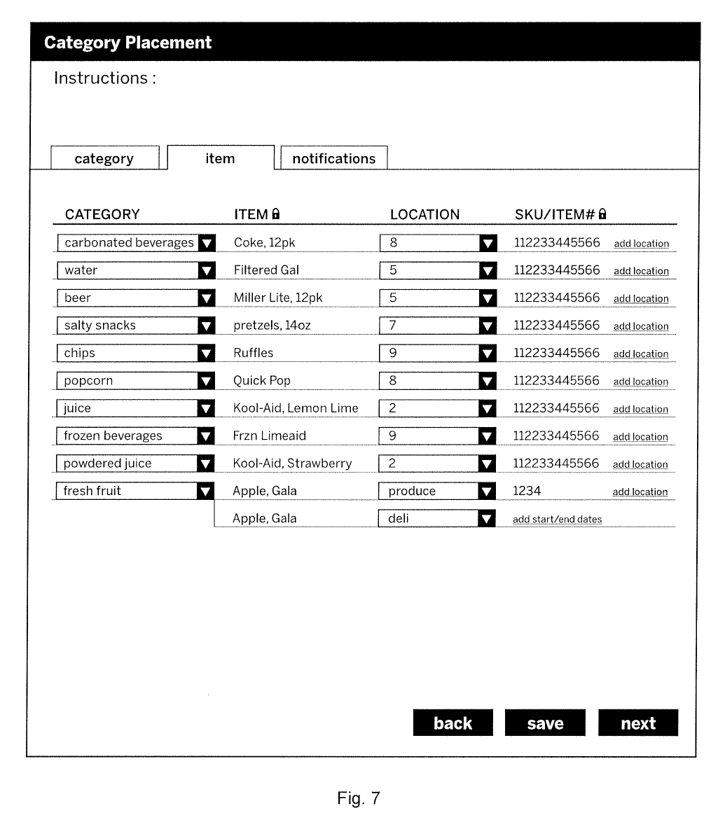

FIG. 7 shows a sample screen display for the item tab which allows for temporary movement of individual items for store promotions or other non-permanent events. The screen allows dates to be set so that the additional locations are automatically deleted after the entered date. The store simply selects “add location” and an additional location of the same item will be added to the list, as shown at the bottom of the screen for the item “Apple, Gala.”

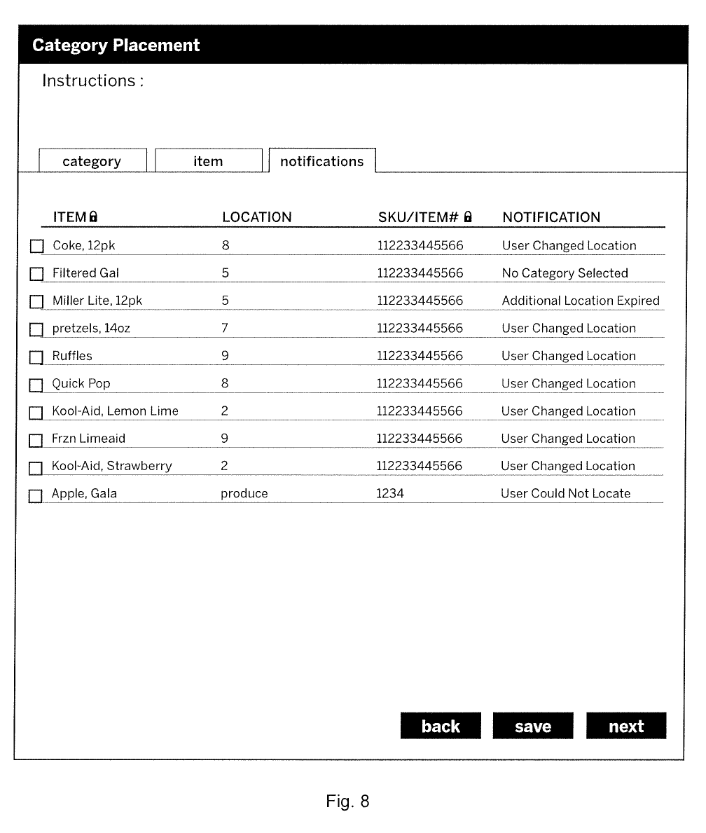

As shown in FIG. 8, the notifications tab shows items that have been flagged as being moved or not belonging to a category. This provides a quick reference for products that may require updated locations in the future.

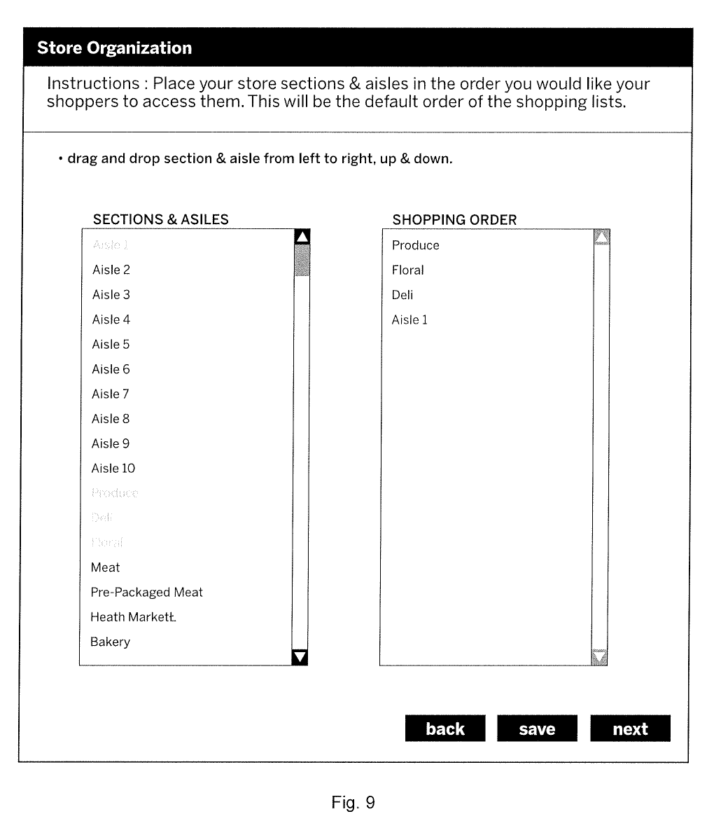

The next step in mapping a store is to organize the order of the aisles or other areas in the store based on their proximity to one another and/or to store entrances and exits. For example, a store may wish to list aisle 2 or 3 ahead of aisle 1 for some reason. This organization is then used to organize user shopping lists as described below. FIG. 9 shows a store organization screen that permits the user to organize the areas within the store. Stores can drag and drop the previously entered aisles and sections in their desired order on the right of the screen. Once an area has been moved to the right side of the screen, it cannot be placed twice.

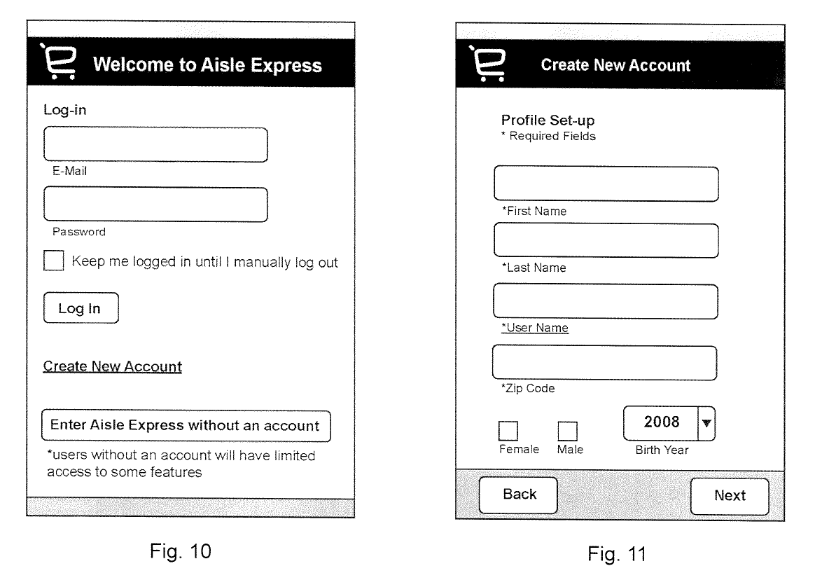

A store may also be mapped by one or more consumers or other users of the store by using one or more of the mobile communications devices 18, 20, 22. FIGS. 10-23 illustrate screen displays that may be displayed on the devices 18, 20, 22 for this purpose.

In some embodiments, users may be required to download a mobile application to their mobile devices 18, 20, 22 from one of the host computers 14, 16 to map a store and perform other aspects of the invention. In other embodiments, the users can map a store and use other features of the invention by simply accessing the website hosted by the host computer 12. In still other embodiments, some of the invention's features may be provided by the website and others by a downloaded mobile application.

Upon opening the mobile application and/or accessing the website for the first time, a user may be asked to log in or create a new account as shown in FIG. 10. The invention may also permit the user to enter the application without signing in or registering, but this may limit the user's access to some features and prevent the saving of selections. In most cases, users that already have an account and have previously activated the account on an existing mobile device will be recognized and not be required to log in to the system each time they launch the application and/or access the website.

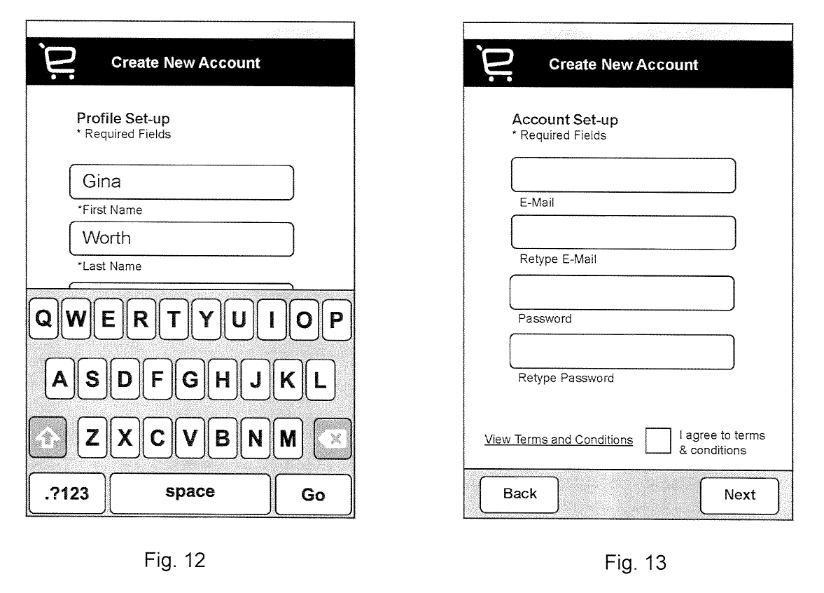

FIG. 11 shows a Create New Account screen where a user is asked to ill in certain fields such as: First Name, Last Name, User Name, and Zip Code, as well as the following non-required fields: Female/Male and Birth Year. Upon completing this page, the user can press a Next button to continue registration or a Back button to return to the screen of FIG. 10. FIG. 12 shows an exemplary screen of a mobile device when the user is entering information. The keyboard may automatically pop up to allow the user to enter information or the device may use Qwerty or other entry methods.

FIG. 13 shows an exemplary screen where the user is required to enter his or her e-mail address, retype the e-mail address, enter his or her password, retype the password, and select an Agree to Terms and Conditions box. These fields will be used to log the user on to the system in the future. Once complete, the user can hit a Next button to go forward or a Back button to return to the previous screen.

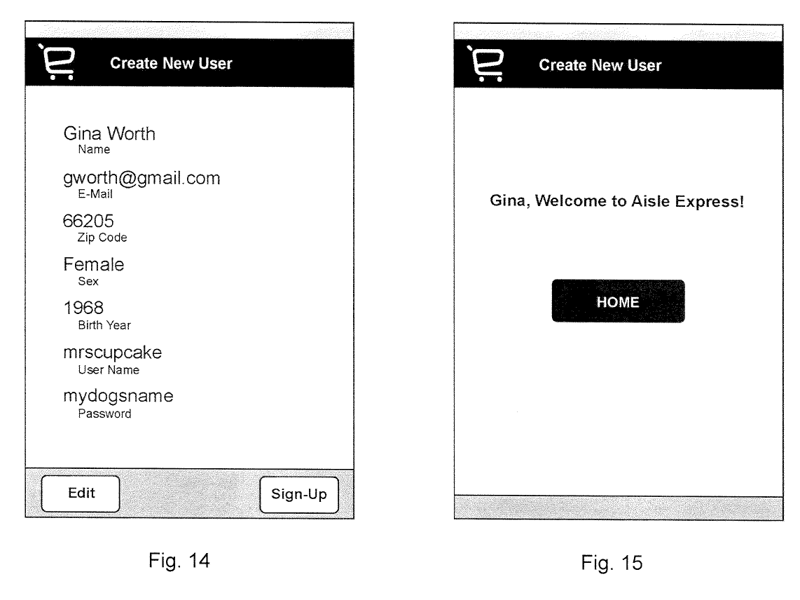

FIG. 14 shows an exemplary screen that summarizes all the information a user has entered. If all of the entries are suitable, the user can select a Sign-Up button to complete the registration process. If the user would like to edit any field, they can select an Edit button which will take them back through the sign-up screens to change the entered data.

FIG. 15 shows an exemplary screen that is displayed when the Sign-Up button is selected. This screen confirms their registration and welcomes them to Aisle Express. The user may then select a Home button to begin using the program.

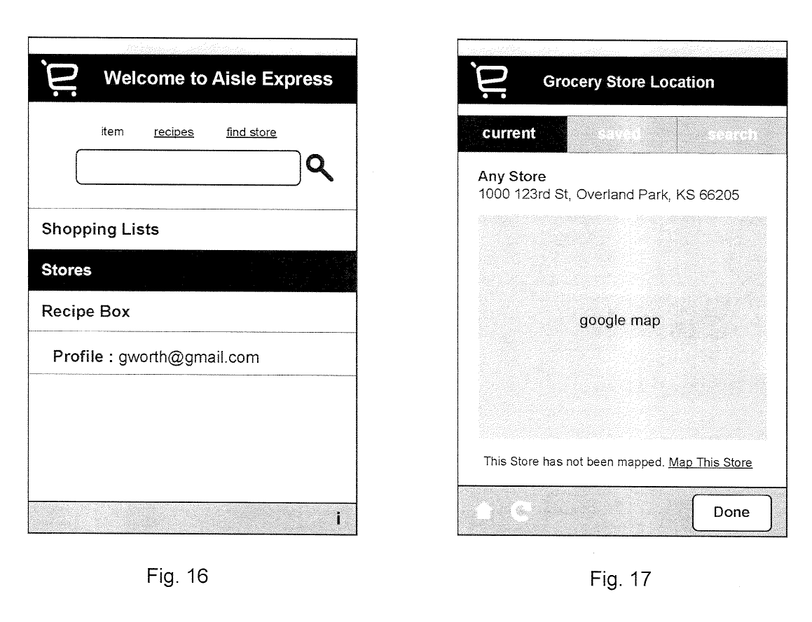

FIG. 16 shows an exemplary home page that may be displayed whenever a user signs in or starts the program. The home page includes a search bar able to search by item, recipe, or store. The home page may also include menu items for: Shopping Lists, Stores, Recipe Box, and Profile (followed by the user's user name.) These are only examples and other menu items such as Project List (for a hardware store) may be displayed.

To add and map a store, a user starts at the home page of FIG. 16 and selects Stores. As with the store mapping by a store representative, the shopper is first prompted to identify the store's aisles and/or other areas. If a store has not been mapped previously and the user does not wish to complete the store layout, a generic store layout will be assumed to include aisles 1-12 and all perimeter spaces as selectable options (produce, dairy, meat department, deli, floral, pharmacy, flooring, etc.) until a user maps the store. It will be made apparent to users that the store has not been mapped even though a generic layout is provided. When a store has not been mapped, the user's items will be categorized (produce, canned goods, soft drinks, electrical items, etc.) and the user may update an item location as they shop utilizing the same methodology described later for updating product locations. The host computer 12 uses the individual product location updates to determine category locations, and in turn, collects sufficient information to map the store by determining the location of product categories. In this way, a store layout can be mapped over time by collecting product location for individual items from more than one user.

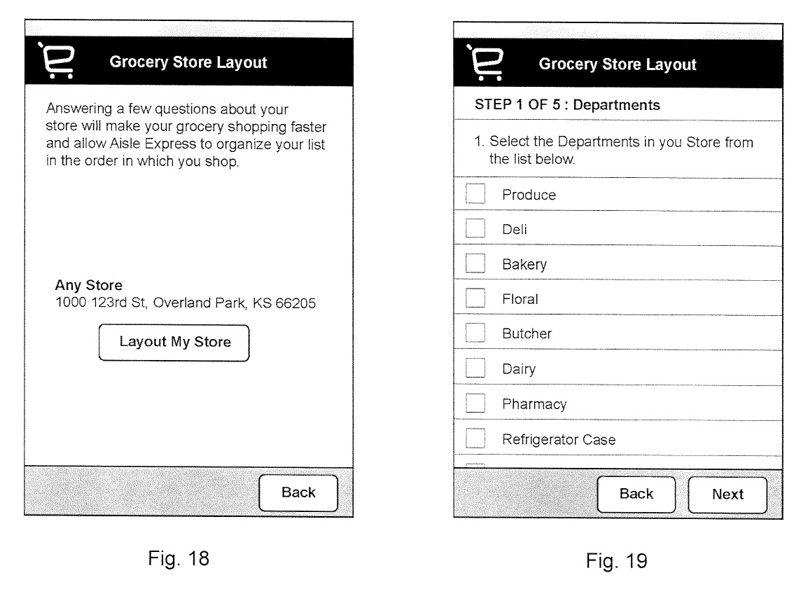

FIG. 17 shows a default screen which shows the current store the user has selected. The bottom of the screen may include a message that alerts the user whether the store or other stores in the chain have been mapped. The user may set up or map the store by selecting Set Up This Store. A Grocery Store Layout page is then displayed as shown in FIG. 18.

The screen of FIG. 18 may first describe to the user what they will be doing to set up the store. The user can choose to go back by selecting the Back button at the bottom of the screen or may continue by choosing the Layout My Store button.

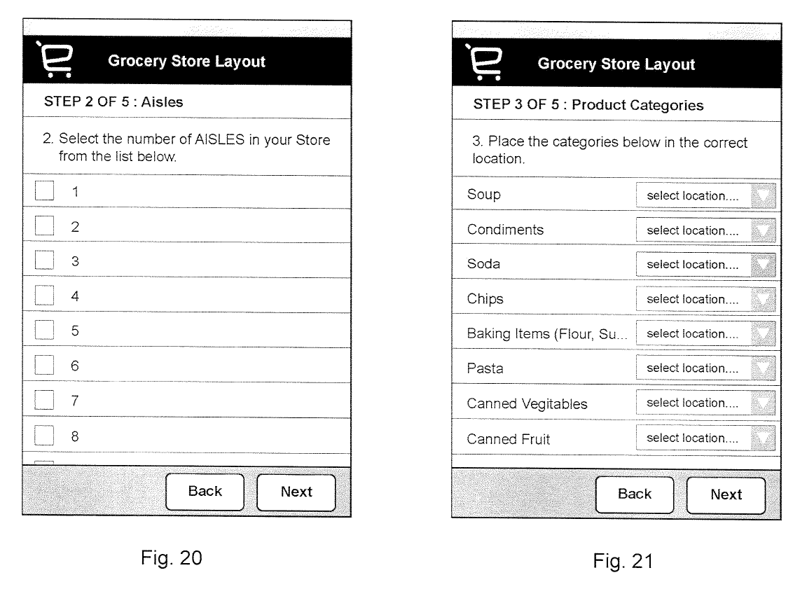

If the Layout My Store button is selected, a screen that permits the user to select each department in the store is displayed as shown in FIG. 19. These are areas that are not identified by aisle numbers and are usually located around the perimeter of the store. The user is then prompted for the number of aisles found in the store in the screen of FIG. 20.

The user may then begin matching product categories to locations in the store as shown in the screen of FIG. 21. The store locations that are listed are the ones identified in the screens of FIGS. 19 and 20.

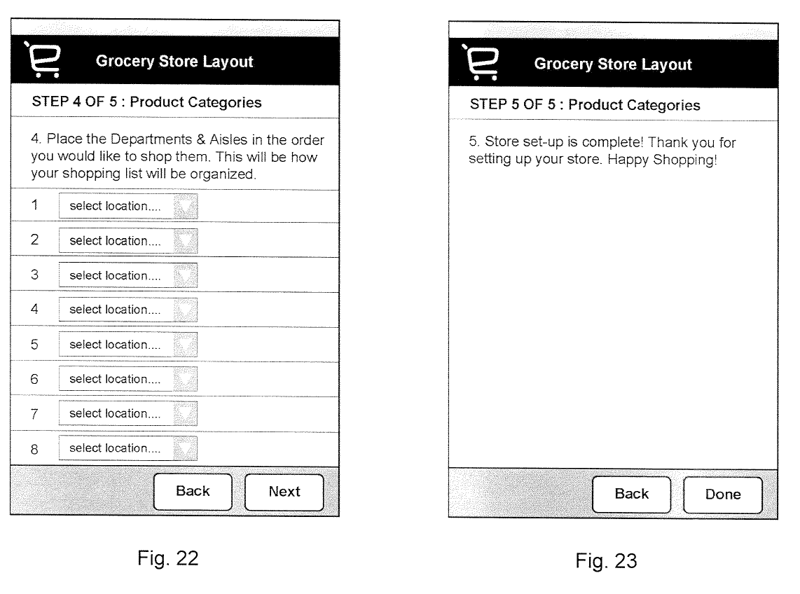

The user may then place the store layout in a desired order using the screen shown in FIG. 22. For example, “1” would be the first place the user would start shopping when they walk in the store. This could be, for example, a produce department, aisle 1, or any other area close to the entrance. This sequential list can later be used to order items in a shopping list to save consumers time when shopping.

Other steps in mapping the store by a shopper are essentially identical to the steps performed by a store representative as described above and are therefor not repeated here.

FIG. 23 shows an exemplary screen confirming set-up of the store. The user may then select a Done button to return to the Stores screen of FIG. 17.

A store may also be mapped, or partially mapped, with the assistance of Global Positioning System (GPS). Specifically, the mobile communications devices 18, 20, 22 or other similar devices may be equipped with GPS receivers or similar navigation technology. A user of one of the devices may be presented with a shopping list (as described in the Item or Store Search section below) that lists a number of desired items. As the user locates each item on the list, the device may prompt the user to check a box or otherwise indicate the item has been found. When the user checks the box or otherwise indicates that the item was found, the GPS receiver records the current position of the device and associates this position with the location of the item. This location information may then be uploaded to one of the host computers. Over time, as many users shop for items in the store in this manner, location information will be captured for all the items in the store, thus mapping the store.

### Item or Store Search

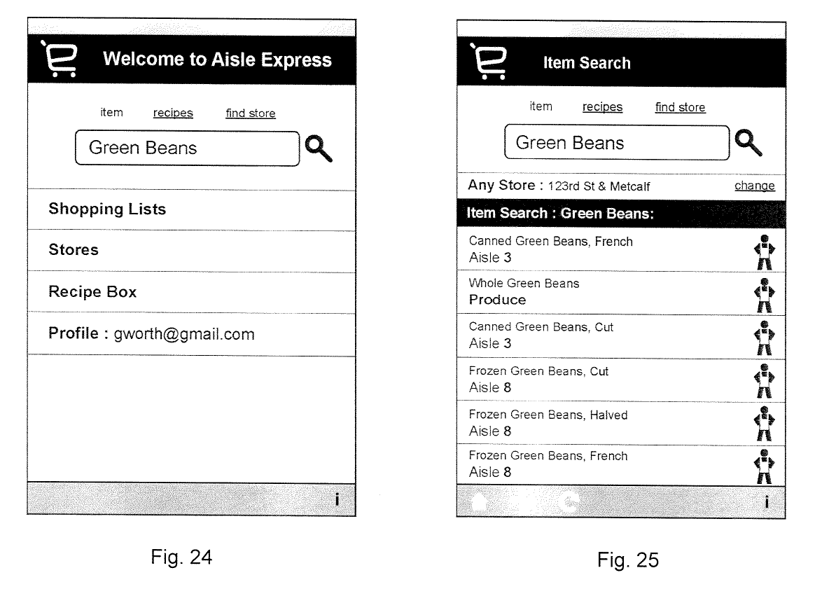

A consumer may also use one of the mobile communication devices to search for an item and/or a store. A user may search for a particular item by selecting “item” from the search bar of the home page as shown in FIG. 24. The user may, for example, type “Green Beans” in the search box and select the magnifying glass icon to initiate the search.

The search results screen of FIG. 25 shows all items pertaining to green beans found in the database associated with the store. In this instance, it is assumed that the user previously selected the store listed at the top of the search panel. As a result, each item that is listed in FIG. 25 is also listed with an aisle location so the user can quickly identify which item they would like, and where in the store it is located. From this screen the user can begin a new search in the same way as from the home page.

The screen of FIG. 25 and other screens illustrated and described herein may include icons with the same or similar functionality throughout all the screens. A House symbol returns to the home screen. A Plus Sign symbol is used to “add” something, which will differ depending on the screen on which the symbol appears. For example, the user may highlight an item in the list and select the Plus Sign symbol to add that item to a shopping list. A ¾ Circle with an Arrow symbol can be used to refresh the screen. An “I” (for Information) can be selected to get more information about a page or get help if the user has a question. These same symbols are preferably used for all different mobile OS and devices; however, there may be some variance in their appearance and locations due to mobile OS capabilities.

If no store had been selected, FIG. 25 displays the message “No Store Selected” and gives the user the ability to add a store. In the illustrated example of FIG. 25, the selected store is listed at the top, and the user is given the option to change this store.

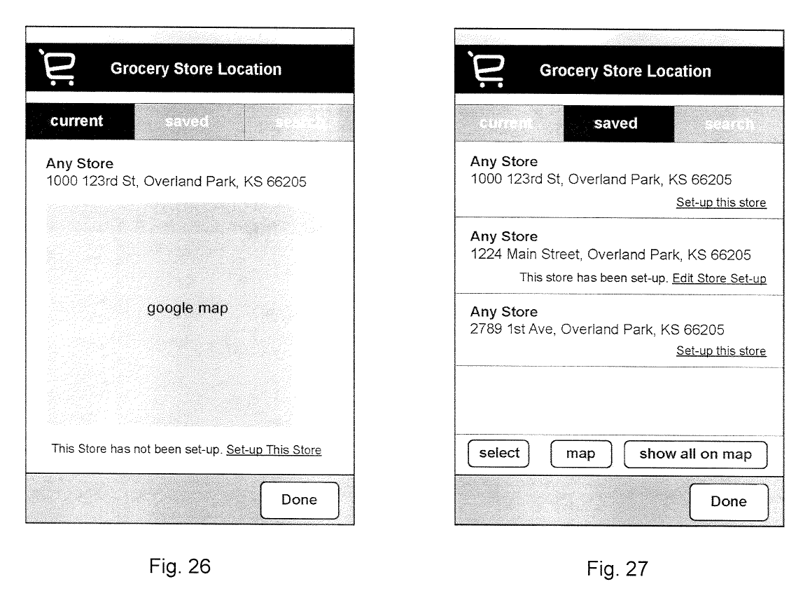

If the user selects the “change” store icon in FIG. 25, a Grocery Store Location page such as the one shown in FIG. 26 is displayed. Similar pages for other types of stores may also be displayed. The Grocery Store Location page has tabs for “current,” “saved,” and “search.” The “current” tab shows the name and address of the store that is currently selected. It will also show the store's location on a map. At the bottom of this page, the user is alerted that this store has not been set up or mapped and provides an option to begin this process. A “Done” button returns to the previous search screen.

If the user selects the “saved” tab, the display screen of FIG. 27 is presented. This screen allows the user to view all of the stores they have previously saved and quickly select one of those stores. They also have the option to view a map of a store or all of the stores of a chain on one map.

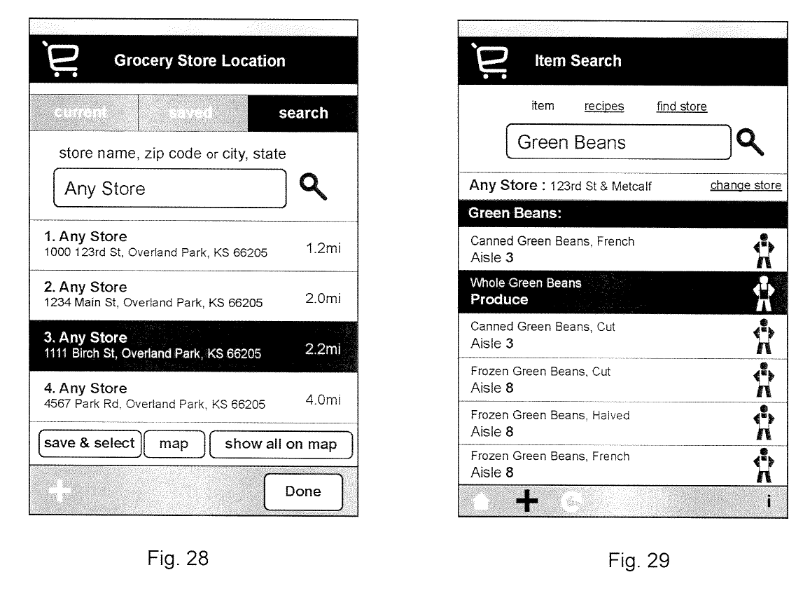

If the user selects the “Search” tab on the screens of FIG. 26 or 27, the display screen of FIG. 28 is displayed. This page allows the user to search for stores by store name, zip code, or city and state. If the user's mobile communication device has a GPS receiver or is otherwise able to know where the user is located, the host computer will return a list of stores in order based on distance from the user at the time of the search. For each result, the store name, address, and distance from the user will appear. The user has the option to “select & save” a store, show a store on a map, or show all of the stores on one map. Once the user selects a store and chooses “save & select,” the user will be returned to the search screen of FIG. 27 where the new store will appear at the top, and the locations will have been updated to reflect the new store.

FIG. 29 shows the Item Search screen again. After the user has searched for an item and found it, they can then add the item to their shopping list. To do this, the user will touch the item on the screen to highlight the item and then touch the Plus symbol at the bottom of the screen.

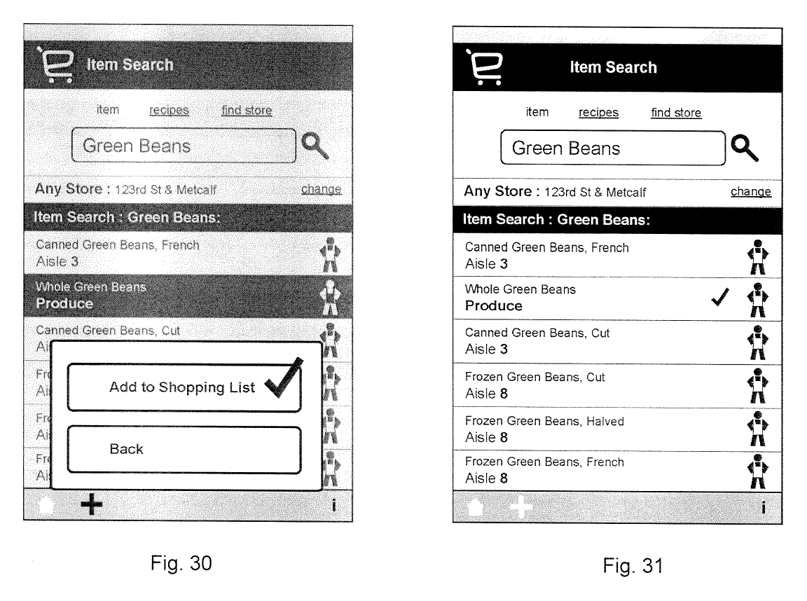

Before the item is added directly to the shopping list, a confirmation box will appear as shown in the screen of FIG. 30. When the confirmation box is displayed, the items in the background are no longer selectable. A “Back” selection returns to the “Item Search” screen. The user can select “Add to Shopping List” to confirm the item's addition to the list. Once an item has been added to a shopping list, a checkmark will appear letting the user know the item is in their shopping list as shown in FIG. 31.

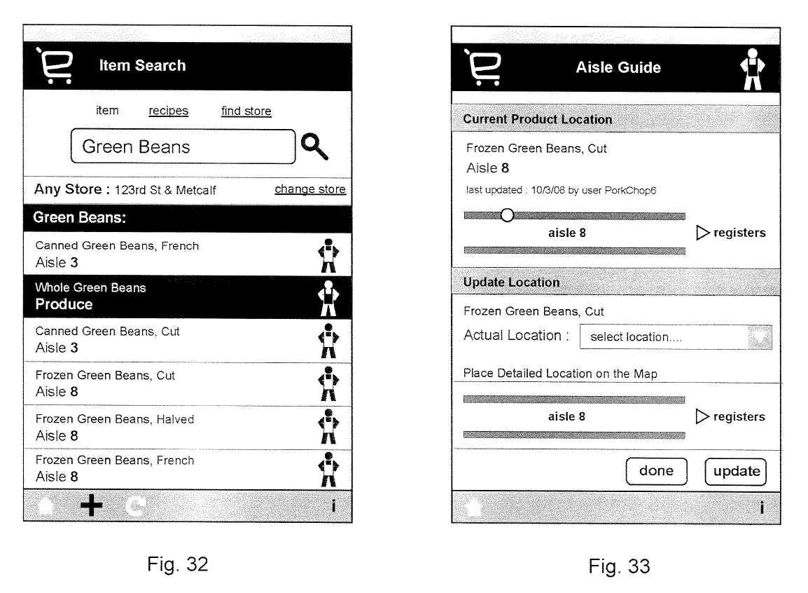

As shown in FIG. 32, an Aisle Guide icon may appear on the right side of each displayed item. The icon can appear both in the shopping list screens and in the item search screens. The Aisle Guide icon can be selected to find out more information about the location of an item or to update the location of an item if it is not in the location listed. In FIG. 32, a user is looking for Frozen Green Beans, Cut and does not find them, and therefore selects the Aisle Guide next to the item to display an Aisle Guide screen as shown in FIG. 33.

The upper half of the Aisle Guide screen shows the item's current assigned location. This is a detailed view of the aisle shown by two gray bars representing the aisle and a red dot to signify the item's location within the aisle. The date the item's location was located as well as the name or other identifier of the person who updated the location may also be displayed. The lower half of the Aisle Guide screen allows the user to input the actual location of the product by placing the red dot on the location.

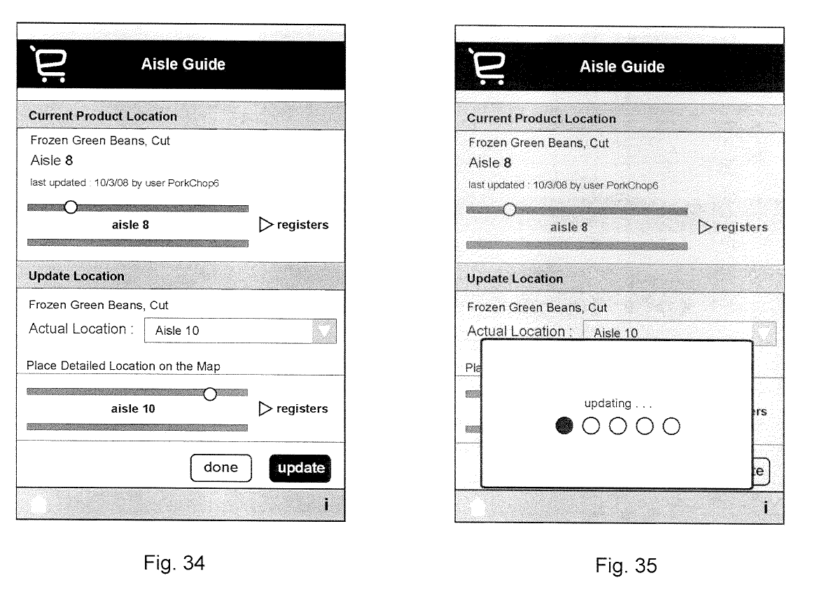

FIG. 34 shows a screen indicating that the user has found the Frozen Green Beans, Cut on aisle 10 and selected Aisle 10 as the actual location of the item. The user then places the red dot over the approximate location in Aisle 10 where the item was found. The user then selects the “update” button” to upload the new location information to the host computer.

FIG. 35 shows a screen with a status box to let the user know the information is updating. While the status box is displayed, items in the background are no longer selectable.

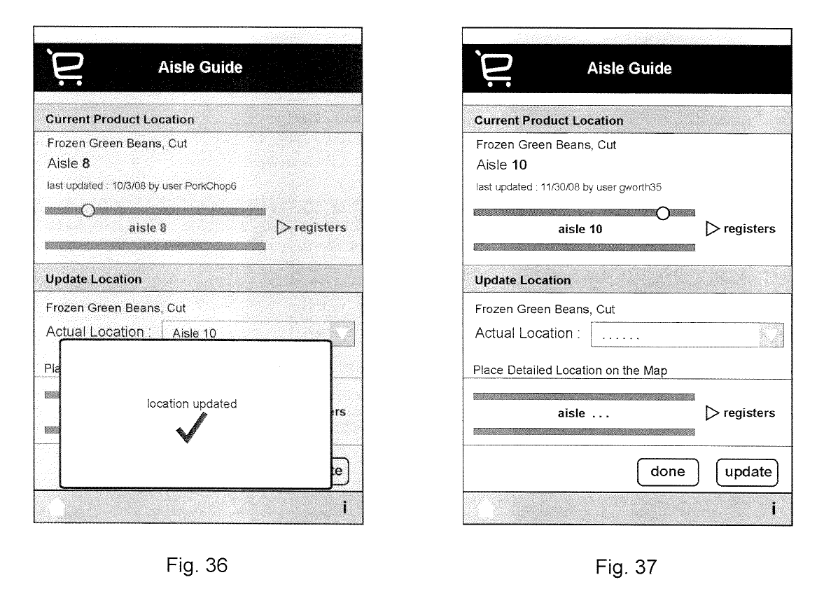

After a product's new location has been uploaded, the status box will then confirm with a box reading “location updated” with a green checkmark as shown in FIG. 36. This confirmation box automatically disappears after a few seconds.

After the confirmation box of FIG. 36 has disappeared, the current product location will change to the new location set by the user as shown in the screen of FIG. 37. The user can update the location below if they have made a mistake or select “Done” to return to the “item search” or “shopping list” screens.

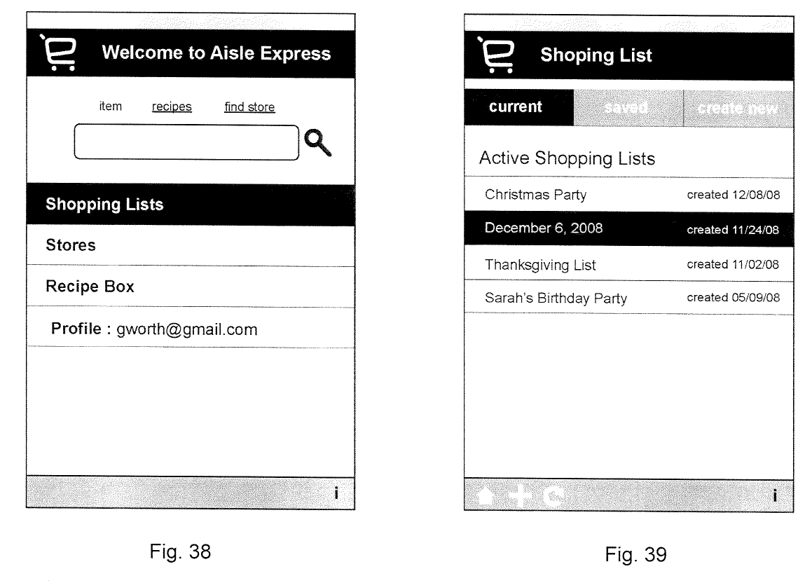

A shopper may also use one of the mobile communication devices to access and use a shopping list. FIG. 38 shows the home page screen again where the user selects “Shopping Lists.” If the user has not created an account or logged into their account, they will not be able to select “Shopping Lists.”

Once in the “Shopping Lists” screen, the user will have three types of shopping lists to select from: “current,” “saved,” and “create new,” as shown in FIG. 39. The “current” tab is selected in FIG. 39 and shows active lists the user has most recently created. This screen shows the name of each shopping list (given by the user) and the date the user created the list. At the bottom of the screen, the user can go to the home page by pressing the Home icon, create a new list by pressing the Plus icon, or refresh the menu by pressing the Refresh icon.

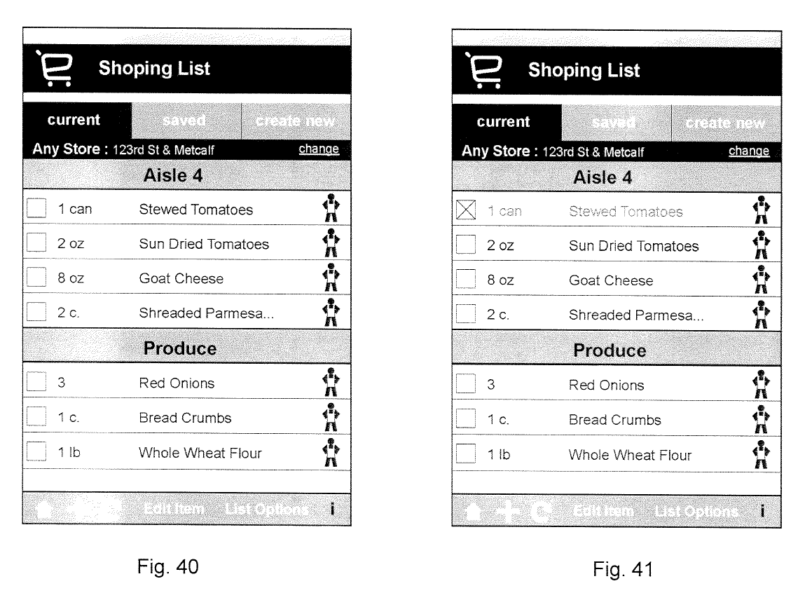

If the user selects the highlighted “Dec. 6, 2008” list, the screen of FIG. 40 is displayed. In FIG. 40, the selected shopping list is categorized by an item's location sequentially based on the store layout. The store the user's list is based on shows on the top of the screen. The general location of the item is shown immediately below the store's address (such as Aisle 4). Next to each item is a box that can be checked as items are added to the cart along with the amount needed of each item, an item description, and the Aisle Guide icon. At the bottom of the screen the user can return to the home screen, add items to the list, refresh the list, “edit item” (such as quantity), and “list options” (such as save this list or send list to a friend.)

When the user finds an item and adds it to the cart, they can check the item off of their shopping list by checking the box as shown in the display screen of FIG. 41. This grays-out and prevents selection of the item amount and description.

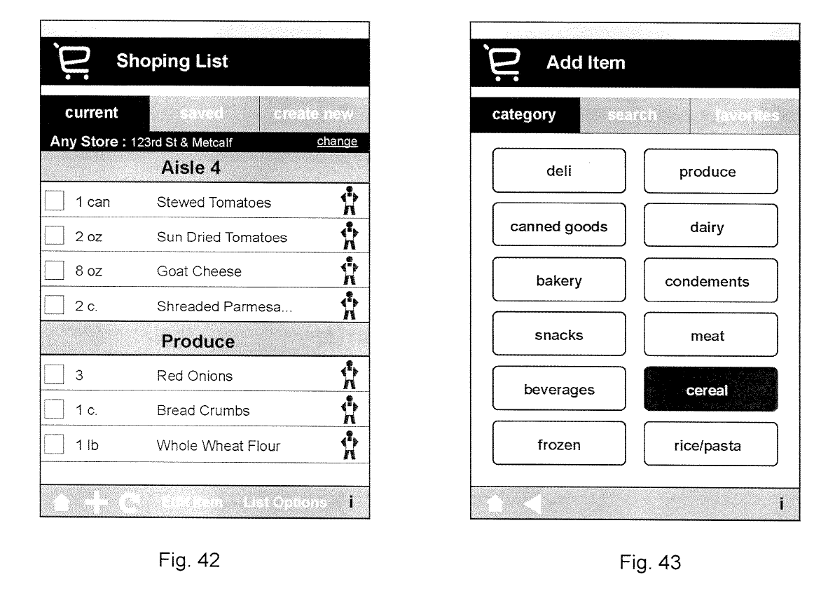

If the user is in a current Shopping List and remembers an additional item they want, they can add it to their list by selecting the Plus icon on the bottom of the screen as shown in the screen of FIG. 42. The user will have the option to add items in a number of ways, which are demonstrated on the following screens. Additionally, users call add items that are not in the Aisle Express product database and assign a category to the item and location (flowers, prescription, deli meat, rolls from the bakery, etc.) These items are then added to the product database; however, the source of the data will be noted as user-generated content.

FIG. 43 shows an “Add Item” screen with tabs that allow the user to search for items by “category,” by “search” by item name, and by “favorites.” The “category” search is the default search method in which items are listed by the family of products. In this case the user is searching for a “cereal” as indicated by the highlighted button.

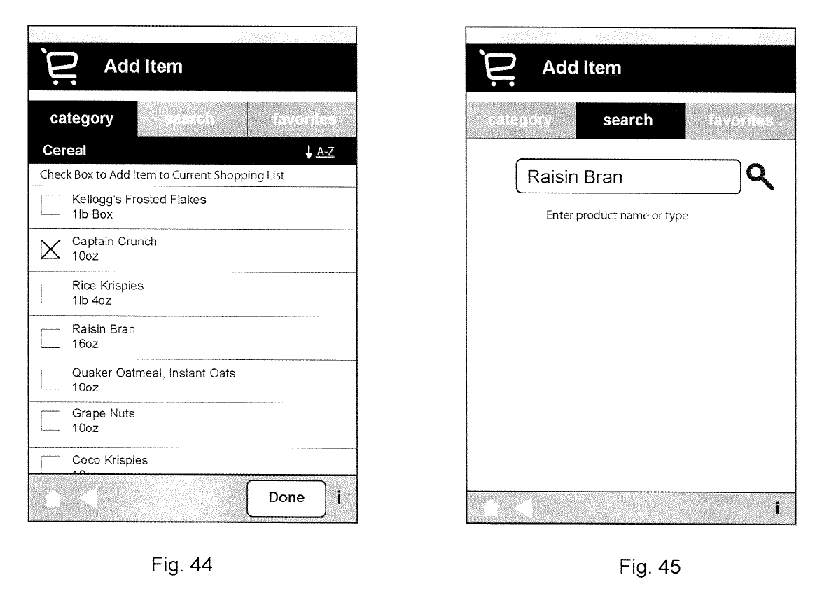

FIG. 44 shows a screen where the “Cereal” heading is now listed at the top of the screen along with the list criteria (such as sort by name alphabetically). The user may check the box next to the item to add it to a shopping list. Once the user has selected all of the items they want, they then select the “Done” button at the bottom of the screen to add items to the list.

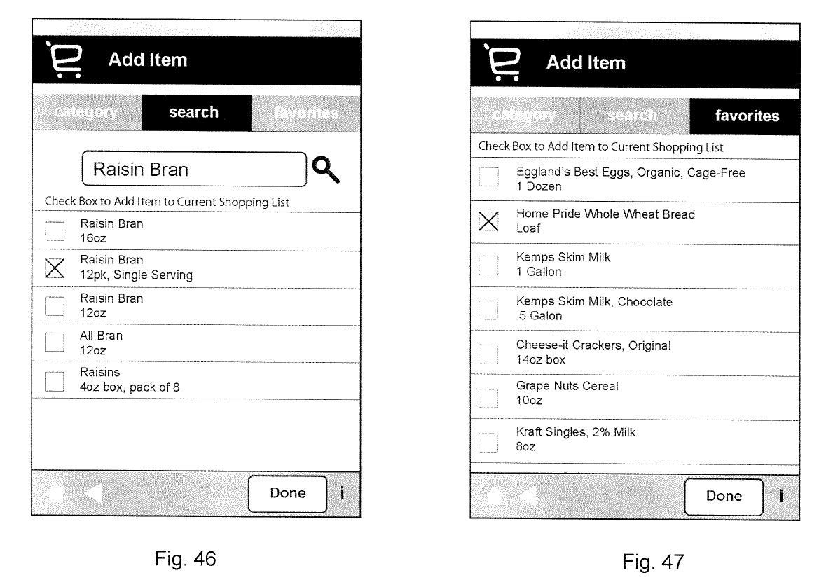

FIG. 45 shows a screen where the user has the option of adding an item to a shopping list by searching. When the “search” tab is selected, a search box is displayed in which the user enters their desired item. FIG. 46 shows a screen where the search results appear based on the relevance to the search term entered. Each entry has a check box which the user can select to add the item to their shopping list. Next to the check box is the item description, including brand name, product name, and size. Once the user finds what they were looking for, they can select the “Done” button, which will take them back to their shopping list.

FIG. 47 shows a screen for the “favorites” tab. Items located here are items that have appeared often on the user's past shopping lists or were chosen as the user's favorites. Each item has a check box, which the user can select in order to add that item to their shopping list. Next to the check box is the item description, including brand name, product name, and size. The user can scroll down the list and add as many items as they would like. Once the user selects the item or items they want to add to their list, they can select the “Done” button, which will take them back to their shopping list.

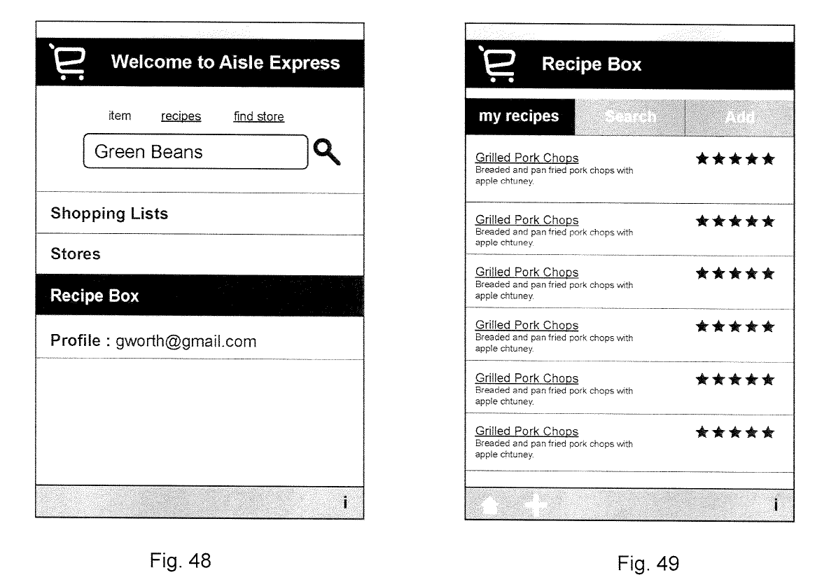

A consumer may also use one of the mobile communication devices to access recipes and add needed ingredients to their shopping list. From the home page, the user may select “Recipe Box” to display the screen of FIG. 48. If the user has not created an account or logged into their account, they will not be able to select “Recipe Box.” Similarly, if the user is building a deck, he or she may access a project list that lists all the items needed to build the deck.

The Recipe Box page shown in FIG. 49 shows saved recipes, allows the user to search for recipes, and enter the user's own recipes. Once a recipe is viewed in detail, the user can add the contents to their shopping list. Each recipe can be viewed by title, listed with a description if it has one, and accompanied by the user's rating they have assigned to it.

Although the invention has been described with reference to exemplary embodiments illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A computer-implemented method of providing shopping assistance to consumers, the method comprising:
receiving at a host computer location information representative of locations of a plurality of items in a store;
providing at least some of the location information to a mobile communications device operated by a consumer to enable the consumer to locate at least some of the items in the store;
receiving from the mobile communications device corrected location information for at least one item in the store; and
updating the location information in the host computer to account for the corrected location information.

2. The method as set forth in claim 1, wherein the store is a grocery store, clothing store, hardware store, toy store, electronics store, warehouse store, discount store, wholesale store, or retail store.

3. The method as set forth in claim 1, wherein the store is a grocery store and the location information includes an aisle number and a shelf position for each of the items.

4. The method as set forth in claim 1, wherein the location information is obtained from an inventory management system of the store.

5. The method as set forth in claim 1, wherein the location information is obtained from consumers as they shop for items in the store.

6. The method as set forth in claim 1, further comprising the steps of receiving a list of desired items from a consumer and providing the location information associated with the desired items to a mobile communications device operated by the consumer so that the consumer can locate the desired items in the store.

7. The method as set forth in claim 1, wherein the mobile communications device is a wireless phone, a phone-enabled personal digital assistant, an MP3 device, a handheld game player, or a wireless communication device.

8. A computer program stored on a computer readable memory device for directing operation of a host computer to assist consumers while shopping, the computer program comprising:
a code segment for receiving location information representative of locations of a plurality of items in a store;
a code segment for providing at least some of the location information to a mobile communication device operated by a consumer to enable the consumer to locate at least some of the items in the store;
a code segment for receiving from the mobile communication device corrected location information for at least one item in the store; and
a code segment for updating the location information to account for the corrected location information.

9. The computer program as set forth in claim 8, wherein the store is a grocery store, clothing store, hardware store, toy store, electronics store, warehouse store, discount store, wholesale store, or retail store.

10. The computer program as set forth in claim 8, wherein the location information is obtained from an inventory management system of the store,

11. The computer program as set forth in claim 8, wherein the location information is obtained from consumers as they shop for items in the store.

12. The computer program as set forth in claim 8, further comprising a code segment for receiving a list of desired items from a consumer and a code segment for providing the location information associated with the desired items to a mobile communication device operated by the consumer.

13. A computer-implemented method of mapping locations of items in a store, the method comprising:
(a) receiving location information for at least one item in the store from a mobile communication device operated by a consumer;
(b) repeating step (a) for a plurality of consumers each operating a mobile communication device; and
(c) storing the location information received from at least some of the consumers in memory associated with a host computer, the host computer being accessible by the mobile communication devices.

14. The method as set forth in claim 13, further comprising the step of verifying that the location information received from the consumers is accurate.

15. The method as set forth in claim 14, wherein the verifying step includes the steps of comparing location information received from different consumers and disregarding location information from selected consumers if it does not agree with location information received from other consumers.

16. The method as set forth in claim 13, further comprising the step of providing at least some of the location information to mobile communications devices operated by consumers who shop at the store after steps (a) through (c) have been performed to help guide the consumers to the items.

17. The method as set forth in claim 13, wherein the store is a grocery store and the location information includes an aisle number and a shelf position for each of the items.

18. The method as set forth in claim 13, wherein the mobile communications device is a wireless phone, a phone-enabled personal digital assistant, an MP3 device, a handheld game player, or a wireless communication device.

19. A computer-implemented method of mapping locations of items in a store, the method comprising:
receiving from a first source data representative of categories of items in the store and data representative of locations within the store for each of the categories;
receiving from a second source data representative of items found in many stores; and
mapping the data representative of the items found in many stores to the locations in the store based on the categories of items.

20. The method as set forth in claim 19, wherein the store is a grocery store, the locations in the store are aisles, and the categories of items are generic names of the items in each aisle.

21. The method as set forth in claim 19, wherein the first source is an employee or other representative of the store or a shopper in the store.

22. The method as set forth in claim 19, wherein the second source is a data provider.

23. The method as set forth in claim 19, wherein the second source is a consumer.
